(19) United States
(12) Patent Application Publication
(10) Pub. No.: US 2014/0213093 A1
(43) Pub. Date: Jul. 31, 2014

(54) AUTO-LOCKING AUDIOPHILE POWER RECEPTACLE

(71) Applicant: Or Tal, Tel Aviv (IL)

(72) Inventors: Or Tal, Tel Aviv (IL); Ofir Hagag, Moshav Azarya (IL); Roni Cafri, Tel Aviv (IL); Kfir Feldman, Kfar Saba (IL)

(73) Assignee: Or Tal, Tel Aviv (IL)

(21) Appl. No.: 13/947,132

(22) Filed: Jul. 22, 2013

Related U.S. Application Data
(60) Provisional application No. 61/758,975, filed on Jan. 31, 2013.

(51) Int. Cl. H01R 13/627

(52) U.S. Cl. CPC H01R 13/627
USPC 439/352

(57) ABSTRACT

A power receptacle includes two or more socket terminals and a locking mechanism. The socket terminals are configured for receiving respective pins of a mating electrical plug. The locking mechanism is operative to transition between an unlocked state, in which the socket terminals grip the respective pins with a first mechanical pressure, and a locked state in which the socket terminals grip the respective pins with a second mechanical pressure that is higher than the first mechanical pressure.

### CROSS-REFERENCE TO RELATED APPLICATIONS

This application claims the benefit of U.S. Provisional Patent Application 61/758,975, filed Jan. 31, 2013, whose disclosure is incorporated herein by reference.

### FIELD OF THE INVENTION

The present invention relates generally to electrical connectors, and particularly to locking power receptacles.

### BACKGROUND OF THE INVENTION

Various mechanical designs for power plugs and receptacles are known in the art. Some designs incorporate locking mechanisms for preventing accidental unplugging of the plug from the receptacle. For example, U.S. Pat. No. 5,108,301, whose disclosure is incorporated herein by reference, describes a locking electrical cord connector including both male and female contacts. The device includes a housing including a cylindrical cavity. A pair of opposed plungers are mounted for reciprocation in this cavity. An actuator switch in the form of an elliptical disc is mounted for reciprocation in the housing about a center shaft between the plungers. Each plunger is biased into engagement with the outer cam edge of the disc by means of springs. In use, the male connector of another electrical appliance is connected with the female connector of the device. The female end of a second electrical appliance is connected with the male connector of the device. The actuator switch is then turned so that the plungers are forced outwardly against the biasing of the springs. This causes spring metal conducting members in the female and male connectors or contacts to bow outwardly and press against the cooperating male and female connectors of the other appliances so as to positively hold all the connectors together.

As another example, U.S. Pat. No. 5,197,897, whose disclosure is incorporated herein by reference, describes a locking electrical cord connector that includes a two-piece housing formed from electrically non-conductive material. A pair of conductors is received in the housing. Each conductor includes a male electrical contact and a female electrical contact. Two locking mechanisms are also provided in the housing. The first cooperates with the male electrical contacts for locking the male electrical contacts to a receptacle. The second cooperates with the female electrical contacts for locking the female electrical contact to a plug of another electrical appliance.

U.S. Pat. No. 7,320,613, whose disclosure is incorporated herein by reference, describes a female locking electrical outlet including an outlet body having slots for apertured prongs of a standard male electrical plug, a pair of receptacles and a locking member mounted within the outlet body. The locking member has locking tabs that engage within apertures in the prongs when the outlet is in a locked position and the electrical plug is connected to the outlet. The outlet has a release mechanism with a release member for engaging the locking member and to transition the locking member from the locked position to an unlocked position.

U.S. Pat. No. 8,449,311, whose disclosure is incorporated herein by reference, describes an audio plug connector device comprising an audio plug body, a connector portion coupled to the audio plug body, and an expanding member extending from the audio plug body, wherein the expanding member radially expands from a first diameter to a second diameter to prevent disengagement from a receptacle is provided.

### SUMMARY OF THE INVENTION

An embodiment of the present invention that is described herein provides a power receptacle, which includes two or more socket terminals and a locking mechanism. The socket terminals are configured for receiving respective pins of a mating electrical plug. The locking mechanism is operative to transition between an unlocked state, in which the socket terminals grip the respective pins with a first mechanical pressure, and a locked state in which the socket terminals grip the respective pins with a second mechanical pressure that is higher than the first mechanical pressure.

In an embodiment, a galvanic contact between the socket terminals and the respective pins has a first surface area in the unlocked state and a second surface area, larger than the first surface area, in the locked state. In another embodiment, an electrical resistance between the socket terminals and the respective pins has a first value in the unlocked state and a second value, smaller than the first value, in the locked state.

In a disclosed embodiment, the locking mechanism is operative to vary a mechanical pressure applied to the pins by the socket terminals continuously between the first and the second mechanical pressures when transitioning between the unlocked and locked states.

In yet another embodiment, the locking mechanism is actuated to transition from the unlocked state to the locked state by pushing of the mating electrical plug into the power receptacle. In still another embodiment, the locking mechanism is configured to be disengaged, so as to transition from the locked state to the unlocked state, by pulling of the mating electrical plug, or a cable attached to the mating electrical plug, from the power receptacle.

In some embodiments, the locking mechanism is configured such that a mechanical pressure applied by the socket terminals to the respective pins has a local minimum in the locked state. In some embodiments, the locking mechanism is configured to provide tactile feedback to a user holding the mating electrical plug, upon entry into and exit from the locked state.

In some embodiments, the power receptacle includes a base assembly and a socket assembly. The socket assembly includes the socket terminals and is movable relative to the base assembly. The locking mechanism is operative to apply the unlocked state at a first position of the socket assembly relative to the base assembly, and to apply the locked state at a second position of the socket assembly relative to the base assembly, different from the first position.

In an embodiment, the locking mechanism includes at least one slanted wedge that is operative to press a respective socket terminal against a corresponding pin of the mating electrical plug with a pressure that varies as a function of a position of the socket assembly relative to the base assembly. In an alternative embodiment, the locking mechanism includes at least one shaft having a first end anchored to the base assembly and a second end that is operative to press a respective socket terminal against a corresponding pin of the mating electrical plug with a pressure that varies as a function of a position of the socket assembly relative to the base assembly.

In an embodiment, the power receptacle includes wire connection terminals that are fixed to the base assembly and are configured to connect respective electrical wires to the socket terminals, and flexible electrically-conducting elements that connect the wire connection terminals to the respective socket terminals. In an example embodiment, the locking mechanism is actuated by an electrical actuation mechanism. Alternatively, the locking mechanism may be actuated by a manual actuation mechanism.

There is additionally provided, in accordance with an embodiment of the present invention, a power receptacle including at least first and second receptacles for receiving respective mating electrical plugs. The first receptacle includes two or more socket terminals for receiving respective pins of a mating electrical plug, and a locking mechanism that is operative to transition between an unlocked state, in which the socket terminals grip the respective pins with a first mechanical pressure, and a locked state in which the socket terminals grip the respective pins with a second mechanical pressure that is higher than the first mechanical pressure.

In an embodiment, the second receptacle does not include any locking mechanism. In another embodiment, the second receptacle comprises a respective locking mechanism. In an example embodiment, the locking mechanism of the second receptacle operates independently of the locking mechanism of the first receptacle. Alternatively, the locking mechanism of the second receptacle may operate jointly with the locking mechanism of the first receptacle.

The present invention will be more fully understood from the following detailed description of the embodiments thereof, taken together with the drawings in which:

### BRIEF DESCRIPTION OF THE DRAWINGS

FIG. 1 is an isometric exploded view of an auto-locking power receptacle, in accordance with an embodiment of the present invention;

FIG. 2 is a side-view cross-section of an auto-locking power receptacle, in accordance with an embodiment of the present invention;

FIGS. 3A-3C are side-view cross-sections of an auto-locking power receptacle at different pressure levels, in accordance with an embodiment of the present invention;

FIGS. 4A-4C are side-view cross-sections of another auto-locking power receptacle at different pressure levels, in accordance with an alternative embodiment of the present invention; and

FIG. 5 is an isometric view of a spring mechanism used in an auto-locking power receptacle, in accordance with an embodiment of the present invention.

### DETAILED DESCRIPTION OF EMBODIMENTS

### Overview

Embodiments of the present invention that are described herein provide improved electrical receptacle configurations, which comprise locking mechanisms. The disclosed locking mechanisms apply large mechanical pressure between the socket terminals of the receptacle and the corresponding pins of the mating electrical plug. As a result, the socket terminals hold the pins with a firm grip, the effective contact area that provides galvanic contact between the socket terminals and the pins is larger, and the electrical resistance between the socket terminals and the pins becomes smaller.

Several examples of receptacles and locking mechanisms are described herein. The mechanisms are typically auto-locking, in the sense that locking is triggered and performed by the action of pushing the plug into the receptacle. Moreover, the disclosed receptacles are configured to receive standard electrical plugs, and do not require any modification on the plug side.

Moreover, some of the disclosed locking mechanisms are also auto-unlocking, meaning that the locking mechanism of the receptacle is disengaged and released by a pulling action applied to the mating plug or cable. This feature is important for compliance with safety standards. Auto-unlocking also prevents situations in which the cable detaches from a locked plug when pulled.

In one example embodiment, the receptacle comprises a base assembly, and a socket assembly that is pushed toward the base assembly as the plug is pushed into the receptacle. As the plug is pushed, slanted wedges in the base assembly gradually increase the gripping force that the socket terminals apply to the pins.

In another example embodiment, the receptacle comprises shafts that are anchored to the base assembly at one end and to a respective socket terminal at the other end. As the plug is pushed further into the receptacle, the shafts gradually increase the gripping force applied to the pins.

Further alternatively, various other suitable locking mechanisms can be used. The disclosed receptacles may be part of larger receptacles, e.g., a duplex receptacle. Several examples of alternative locking mechanisms and duplex receptacles are described below.

The disclosed electrical receptacles, having improved contact quality, are useful in a variety of applications. For example, high-end audio systems (sometimes referred to as “audiophile systems”) may use these receptacles to minimize audio distortion. As another example, electrical equipment operating in explosive atmosphere conditions may use the disclosed receptacles to eliminate sparks, and hospital-grade equipment may use these receptacles to ensure reliable power supply.

### Operation Principles and Example Applications

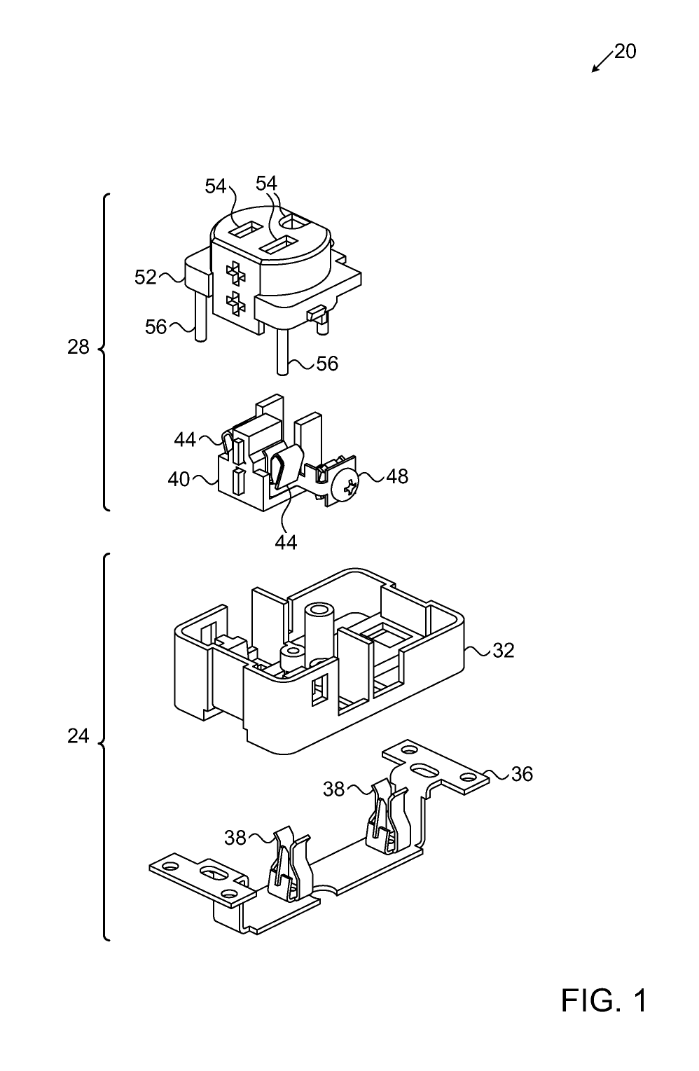

FIG. 1 is an isometric exploded view of an auto-locking power receptacle 20, in accordance with an embodiment of the present invention. In the present example, receptacle 20 complies with the U.S. National Electrical Manufacturers Association (NEMA) 5-15 standard. In other words, receptacle 20 is configured to provide the auto-locking functionality while mating with a standard NEMA 5 plug (not shown in the figures).

In alternative embodiments, the disclosed techniques can be used to produce receptacles complying with any other suitable standard or specification, such as, for example other NEMA standards (e.g., NEMA 1, NEMA 6, NEMA 10 or NEMA 14, including various current-handling ratings of these receptacles), European CEE receptacles such as CEE 7/7 (“Schuko”), British BS1363 receptacles, among others. As will be explained below, the disclosed techniques are important for compliance with safety standards, such as UL-498 and NEC/NFPA.

The embodiments described herein refer mainly to plugs having flat pins, usually with a rectangular cross-section. This choice, however, is made purely for the sake of conceptual clarity. In alternative embodiments, the disclosed techniques can be applied in a similar manner to various other types of pins, for example round-cross-section pins such as the pins of “Schuko” plugs.

Receptacle 20 comprises two main assemblies—A base assembly 24 and a socket assembly 28. Base assembly 24 comprises a housing 32 and a metallic base-plate 36. Base-plate 36 is typically grounded and comprises one or more ground socket terminals 38 of the receptacle. In alternative “isolated ground” configurations, however, the ground socket terminals are not connected to the base-plate. Socket assembly 28 comprises a front cover 52 and a socket body 40, both typically made of plastic or other electrically-insulating material.

Front cover 52 has openings 54 for receiving the pins of the mating plug. Socket body 40 comprises socket electrical terminals 44 for receiving corresponding pins of the mating electrical plug. Each socket terminal 44 is connected to a respective screw 48 or other means for connecting electrical wiring to the receptacle.

Socket assembly 28 is movable relative to base assembly 24 (along the vertical axis, in the frame of reference of FIG. 1). When the mating plug is pushed into receptacle 20, socket assembly 28 is pushed toward base assembly 24. In the present example, socket assembly 28 comprises slide pins 56 that slide inside corresponding holes (not shown) in base assembly 24 to act as rails. The movement of socket assembly 28 engages and releases the locking mechanism of receptacle 20, as will be explained in detail below.

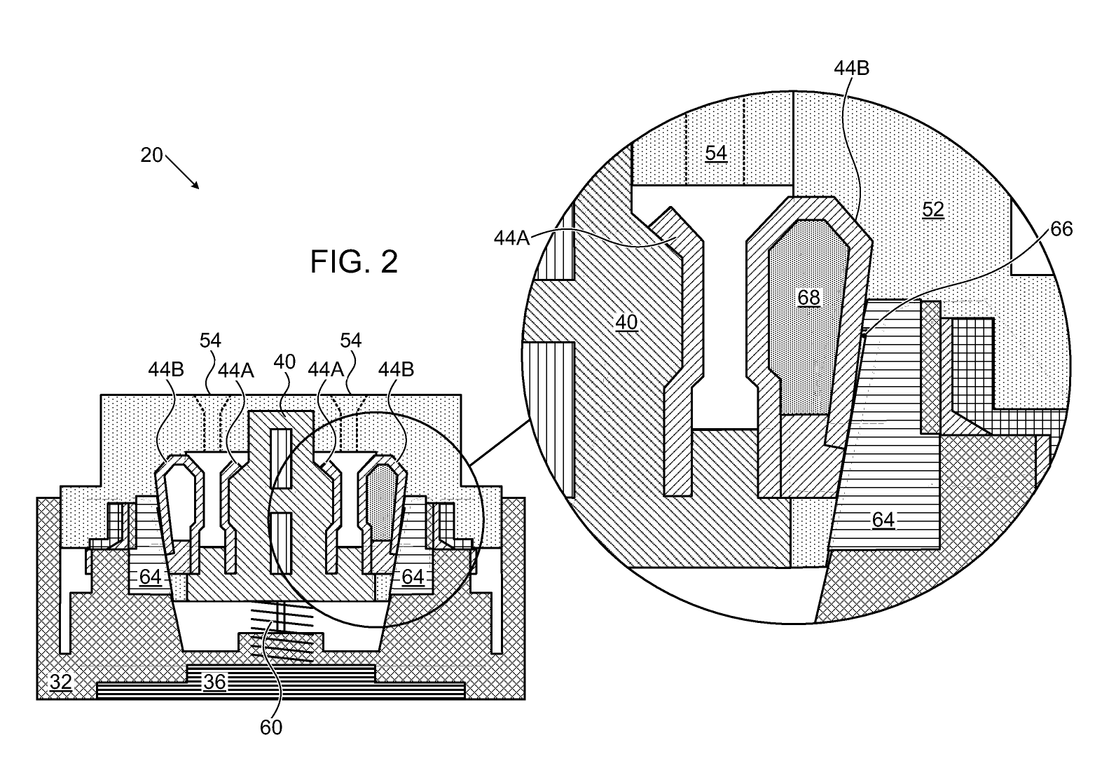

FIG. 2 is a side-view cross-section of receptacle 20, in accordance with an embodiment of the present invention. This view shows the various receptacle components described in FIG. 1 above. In addition, the figure shows a spring 60 that is fitted between housing 32 and socket body 40. Spring 60 resists the pushing of socket assembly 28 toward base assembly 24.

The enlarged section in FIG. 2 focuses on the auto-locking mechanism of receptacle 20. In the present example, each socket terminal comprises a metallic lead 44, which is shown in the figure as two elements denoted 44A and 44B. (For the sake of clarity, each of elements 44A and 44B is referred to herein as a lead, even though both elements are part of the same lead 44 that is folded into shape.) Lead 44B is loop-shaped, and optionally filled with a compressible material 68 such as rubber or plastic. Base assembly 24 comprises two slanted wedges 64, one wedge against each socket terminal 44.

When the electrical plug is fitted in receptacle 20, each pin fits in a respective socket terminal 44. (In the enlarged section, a pin fits into the gap between leads 44A and 44B, via opening 54 in cover 52.) When the plug is pushed into the receptacle, the plug body touches socket body 40. Further pushing action pushes socket body 40 toward housing 32.

As the socket body moves toward the housing (downward in FIG. 2), wedge 64 applies a gradually-increasing force on lead 44B. If rubber 68 is used, the force gradually compresses the rubber. As a result, as the socket body moves toward the housing, socket terminal (made-up of leads 44A and 44B) grips the mating pin with a progressively-increasing pressure.

The example of FIG. 2 shows the receptacle 20 at some intermediate position between its unlocked and locked states. As will be seen further below, when reaching the locked state, the edge of lead 44B fits into a groove 66 in wedge 64.

In the example of FIG. 2, auto-locking is used for the power terminal and not for the ground terminal. In alternative embodiments, however, auto-locking may be applied to the ground terminal of the receptacle, as well.

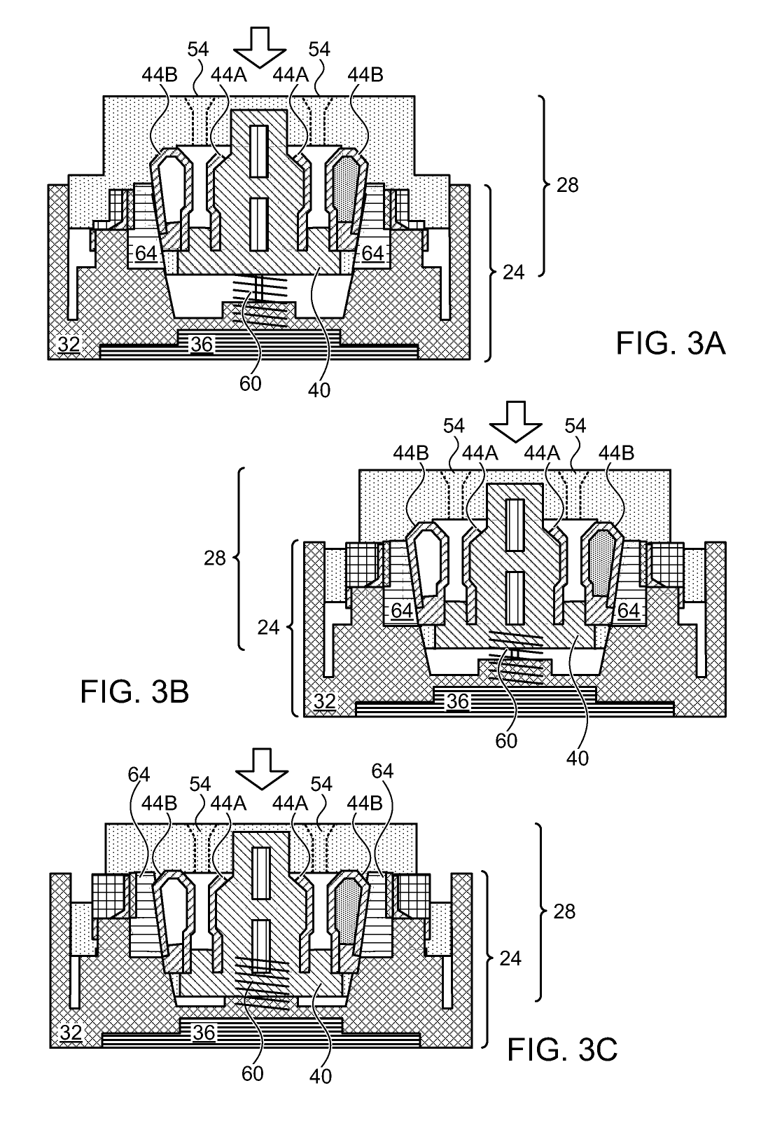

FIGS. 3A-3C are side-view cross-sections of receptacle 20 at different pressure levels, in accordance with an embodiment of the present invention. FIG. 3A shows the receptacle in its unlocked state. In this state, socket assembly 28 is furthest away from base assembly 24.

As a result, wedges 64 exert minimal force on leads 44B, and therefore the gripping pressure that socket terminals 44 apply to the mating pins is minimal. The effective galvanic contact area between the socket terminals and the plug pins (i.e., the actual contact area through which current flows) is also minimal. Nevertheless, there is typically some extent of electrical connection between the socket terminals and the pins, even in the unlocked state of the receptacle. The gripping pressure in this state allows for the insertion and removal of the plug pins.

FIG. 3B shows the receptacle in an intermediate state, between the unlocked state and the locked state. At this stage, socket assembly 28 is mid-way between its highest (unlocked) position and lowest (locked) position. Wedges 64 exert some intermediate force on leads 44B, and therefore the gripping pressure that socket terminals 44 apply to the mating pins is medium. As the socket assembly is pushed further toward the base assembly, the gripping force increases due to increasing pressure exerted by wedges 64 on leads 44B.

FIG. 3C shows the receptacle in its locked state. In this state, socket assembly 28 is pushed nearest to base assembly 24. At this position wedges 64 exert a high pressure on leads 44B, and therefore the gripping pressure that socket terminals 44 apply to the mating pins is high. The effective galvanic contact area between the socket pins and the pins is therefore also high. The electrical resistance between the socket terminals and the pins at the locked state is minimal.

As can be seen in the figure, in the locked state lead 44B is held in place by groove 66 of wedge 64. Using this groove, socket assembly 28 is held in the locked state even if the mating plug is not pushed down any longer. In other words, the force exerted by groove 66 on the socket assembly is sufficiently larger than the force exerted by spring 60, so as to hold the socket assembly locked in place. The groove also provides tactile feedback to the user—a tactile ‘click’ to signal that the plug and receptacle are locked. In the locked state, the gripping pressure of the socket terminals on the pins has a local minimum, so as to retain the plug in a stable position.

In order to release the lock, the mating plug needs to be pulled away from the receptacle. When pulled with sufficient force, lead 44B is released from groove 66 and spring 60 pushes the socket assembly away from the base assembly toward the unlocked state.

It is important to note that the auto-locking mechanism described above is also auto-unlocking. In other words, the locking mechanism is disengaged (i.e., transitions from the locked state to the unlocked state) by a pulling action applied to the mating plug or to the cable. This feature is naturally not supported by locking mechanisms that aim to prevent accidental disconnection of the plug. Auto-unlocking, however, is important (and possibly mandatory) for compliance with safety requirements. For example, safety standards such as UL-498 require the plug to disconnect from the receptacle in response to a specified pulling force. Moreover, auto-unlocking prevents situations in which the cable detaches from a locked plug when pulled.

### Alternative Mechanical Configurations

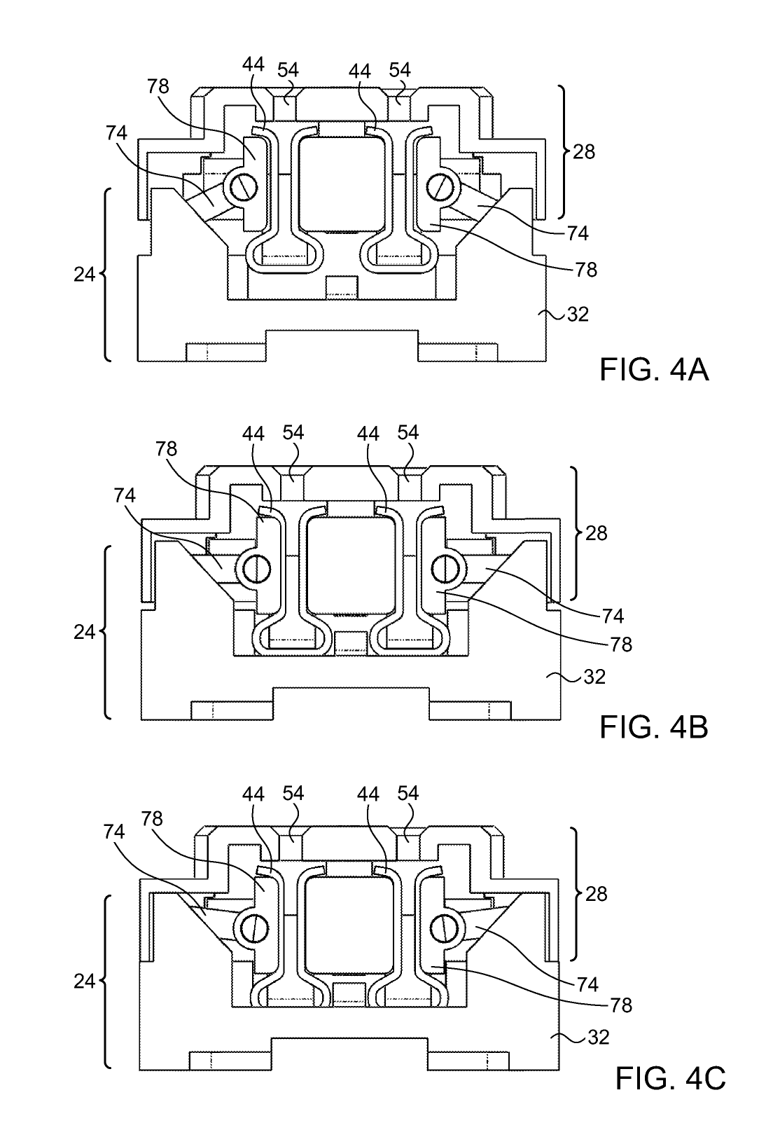

FIGS. 4A-4C are side-view cross-sections of another auto-locking power receptacle, at different pressure levels, in accordance with an alternative embodiment of the present invention. The locking mechanism in this example uses geometrical locking, and is also auto-unlocking as described above.

In the present example, the locking mechanism comprises shafts 74, one shaft for each socket terminal 44 to be locked. Each shaft 74 is anchored at one end to base assembly 24. The other end of shaft 74 is coupled to a lead of the respective socket terminal 44. A compressible material 78, such as rubber, mediates between shaft 74 and the lead of the socket terminal. As socket assembly 28 is pushed toward base assembly 24 (by the pushing of the plug into the receptacle), shafts 74 rotate and apply a progressively increasing pressure on the leads, until reaching the locked state.

FIG. 4A shows the receptacle in its unlocked state. In this state, socket assembly 28 is furthest away from base assembly 24. Shafts 74 apply some initial pressure on the leads of socket terminals. There is electrical contact between the socket terminal and the plug pin, but the effective area that provides galvanic contact is relatively small (e.g., as found in conventional receptacles).

FIG. 4B shows the receptacle at some intermediate position between the unlocked and locked states. In this example position, shafts 74 are parallel to the receptacle base, and the pressure they apply to the leads is maximal.

FIG. 4C shows the receptacle in the locked state. In this position, socket assembly 28 is nearest to base assembly 24, and shafts 74 are pushed slightly beyond the parallel position of FIG. 4B above. As a result, the pressure applied to the socket terminal leads is slightly reduced, resulting in a stable locked state that also provides tactile feedback to the user.

(When the plug is pulled in order to unlock the locking mechanism, shafts 74 should again go through the maximum pressure point (FIG. 4B). This resistance holds the mechanism locked.) In other words, the gripping pressure of the socket terminals on the pins has a local minimum at the locked state.

The mechanical receptacle and locking mechanism configurations described above are chosen purely by way of example. In alternative embodiments, any other suitable receptacle and/or locking mechanism can be used. For example, the locking mechanism may be actuated by a suitable electrical actuation mechanism (e.g., engine), not necessarily by the pushing action of the plug into the receptacle. Further alternatively, the locking mechanism may be actuated by a suitable manual actuation mechanism, e.g., a push-button, lever, handle or switch, or by rotating the plug in the socket after insertion.

In some embodiments, a receptacle such as the receptacles of FIGS. 3A-3C or 4A-4C is part of a duplex receptacle, or more generally a larger power receptacle that comprises multiple receptacles. In an example embodiment, both receptacles of the duplex receptacle comprise locking mechanisms as described herein. The locking mechanisms of the two receptacles may operate independently, or they may lock both receptacles jointly (i.e., triggered by the same action, event or actuation mechanism). In another embodiment, only one of the receptacles in the duplex receptacle has a locking mechanism as described herein, and the second receptacle is a conventional non-locking receptacle.

In the embodiments described above, the electrical cable wires connected to socket terminals 44 move together with the socket assembly as the receptacle locks or unlocks. Referring to FIG. 1, for example, screws 48 are part of socket body 40 that moves relative to housing 32. In some cases it is desirable to ensure that the cable wires remain stationary, regardless of the motion of the socket terminals to which they are connected. This requirement may improve the reliability and lifetime of the cable. One possible solution is to fix the screws or other cable connections to the base assembly, and use some flexible electrical connection between the cable connections and the socket terminals.

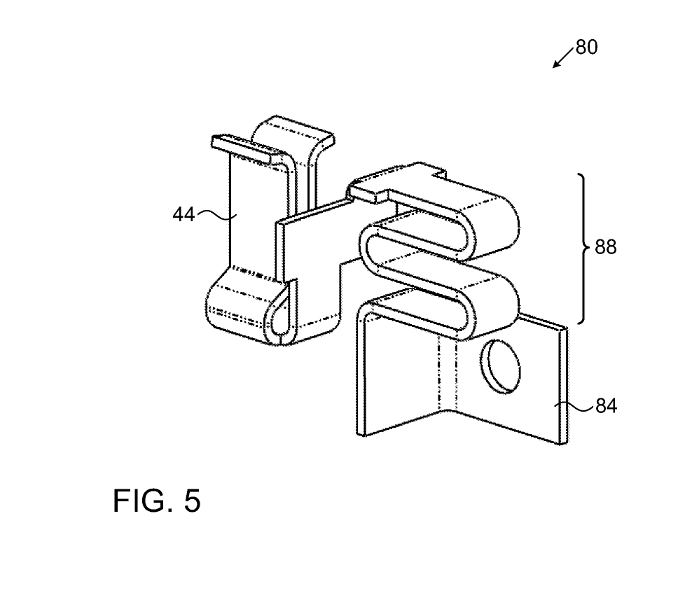

FIG. 5 is an isometric view of a spring mechanism 80 used in an auto-locking power receptacle, in accordance with an embodiment of the present invention. The figure focuses on a single socket terminal 44, for the sake of clarity. As can be seen in the figure, socket terminal 44 is electrically connected to a wire connection terminal 84. A wire can be connected to terminal 84 using, for example, a screw such as screw 48 of FIG. 1.

In this embodiment, terminal 84 (and thus the electrical cable) is fixed rigidly to the receptacle base-plate 36. Socket terminal 44, on the other hand, moves up and down relative to the base-plate. A spring element 88 mediates between the moving socket terminal (44) and the stationary wire connection terminal (84). Spring element 88 is electrically conducting, with sufficient current rating to support the specified amperage of the receptacle.

In alternative embodiments, the receptacle may comprise any other suitable flexible but electrically-conducting connection between the socket terminal and the corresponding wire terminal.

In some embodiments, the auto-locking receptacle comprises a mechanism, which enables the locking mechanism only when the mating plug is fully inserted into the receptacle. Put in another way, this mechanism prevents auto-locking from engaging until the plug is fully inserted. Any suitable mechanism can be used.

In an example embodiment, the locking mechanism has a “double action”: When the user first inserts the plug, the locking mechanism is not engaged regardless of the pushing force. Only after the user inserts the plug fully, lets go and pushes the plug again, the locking mechanism begins to operate. Alternatively, any other suitable mechanism can be used.

In some embodiments, the receptacle comprises an adjustment mechanism for adjusting the pulling force that is needed for unlocking and unplugging the plug from the receptacle. One possible solution is to place a rotatable eccentric element between the two socket terminals 44. Rotation of this block will modify the pressure applied by the block on the socket terminals. As a result, the pulling force that needs to be applied to the plug in order to unlock and unplug it will change. Alternatively, any other suitable adjustment mechanism can be used.

Although the embodiments described herein mainly address auto-locking power receptacles for audiophile equipment, the methods and systems described herein can also be used in other applications, such as in power receptacles specified for explosive atmospheres and in hospital-grade receptacles. Moreover, the disclosed techniques are not limited to power receptacles, and can be used in various other types of connectors. For example, the disclosed locking mechanisms can be used in any suitable application that requires auto-unlocking triggered by pulling of the plug.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A power receptacle, comprising:
a base assembly;
a socket assembly, which is movable relative to the base assembly and which comprises two or more socket terminals for receiving respective pins of a mating electrical plug and for connecting the pins to electrical power; and
a locking mechanism, which is operative to transition between:
an unlocked state, in which the socket assembly, including the socket terminals and the respective pins, is at a first position relative to the base assembly and the socket terminals grip the respective pins with a first mechanical pressure; and
a locked state, in which the socket assembly, including the socket terminals and the respective pins, is at a second position relative to the base assembly, different from the first position, and the socket terminals grip the respective pins with a second mechanical pressure that is higher than the first mechanical pressure.

2. The power receptacle according to claim 1, wherein a galvanic contact between the socket terminals and the respective pins has a first surface area in the unlocked state and a second surface area, larger than the first surface area, in the locked state.

3. The power receptacle according to claim 1, wherein an electrical resistance between the socket terminals and the respective pins has a first value in the unlocked state and a second value, smaller than the first value, in the locked state.

4. The power receptacle according to claim 1, wherein the locking mechanism is operative to vary a mechanical pressure applied to the pins by the socket terminals continuously between the first and the second mechanical pressures when transitioning between the unlocked and locked states.

5. The power receptacle according to claim 1, wherein the locking mechanism is actuated to transition from the unlocked state to the locked state by pushing of the mating electrical plug into the power receptacle.

6. The power receptacle according to claim 1, wherein the locking mechanism is configured to be disengaged, so as to transition from the locked state to the unlocked state, by pulling of the mating electrical plug, or a cable attached to the mating electrical plug, from the power receptacle.

7. The power receptacle according to claim 1, wherein the locking mechanism is configured such that a mechanical pressure applied by the socket terminals to the respective pins has a local minimum in the locked state.

8. The power receptacle according to claim 1, wherein the locking mechanism is configured to provide tactile feedback to a user holding the mating electrical plug, upon entry into and exit from the locked state.

9. (canceled)

10. The power receptacle according to claim 1, wherein the locking mechanism comprises at least one slanted wedge that is operative to press a respective socket terminal against a corresponding pin of the mating electrical plug with a pressure that varies as a function of a position of the socket assembly relative to the base assembly.

11. The power receptacle according to claim 1, wherein the locking mechanism comprises at least one shaft having a first end anchored to the base assembly and a second end that is operative to press a respective socket terminal against a corresponding pin of the mating electrical plug with a pressure that varies as a function of a position of the socket assembly relative to the base assembly.

12. The power receptacle according to claim 1, and comprising wire connection terminals that are fixed to the base assembly and are configured to connect respective electrical wires to the socket terminals, and flexible electrically-conducting elements that connect the wire connection terminals to the respective socket terminals.

13. The power receptacle according to claim 1, wherein the locking mechanism is actuated by an electrical actuation mechanism.

14. The power receptacle according to claim 1, wherein the locking mechanism is actuated by a manual actuation mechanism.

15. A power receptacle, comprising at least first and second receptacles for receiving respective mating electrical plugs, wherein the first receptacle comprises:
a base assembly;
a socket assembly, which is movable relative to the base assembly and which comprises two or more socket terminals for receiving respective pins of a mating electrical plug and for connecting the pins to electrical power; and
a locking mechanism, which is operative to transition between:
an unlocked state, in which the socket assembly, including the socket terminals and the respective pins, is at a first position relative to the base assembly and the socket terminals grip the respective pins with a first mechanical pressure; and
a locked state, in which the socket assembly, including the socket terminals and the respective pins, is at a second position relative to the base assembly, different from the first position, and the socket terminals grip the respective pins with a second mechanical pressure that is higher than the first mechanical pressure.

16. The power receptacle according to claim 15, wherein the second receptacle does not comprise any locking mechanism.

17. The power receptacle according to claim 15, wherein the second receptacle comprises a respective locking mechanism.

18. The power receptacle according to claim 17, wherein the locking mechanism of the second receptacle operates independently of the locking mechanism of the first receptacle.

19. The power receptacle according to claim 17, wherein the locking mechanism of the second receptacle operates jointly with the locking mechanism of the first receptacle.
